(19) United States
(12) Patent Application Publication
(10) Pub. No.: US 2012/0184242 A1
(43) Pub. Date: Jul. 19, 2012

(54) Methods and Systems for Enhancing Wireless Coverage

(75) Inventors: Adam H. Li, San Diego, CA (US); Ning Nicholas Chen, San Diego, CA (US); Ely Tsern, Los Altos, CA (US); Michael Farmwald, Los Altos, CA (US)

(73) Assignee: RAMBUS Inc., Los Altos, CA (US)

(21) Appl. No.: 13/499,194

(22) PCT Filed: Aug. 31, 2010
(86) PCT No.: PCT/US10/47242

§ 371 Date: Mar. 29, 2012

Related U.S. Application Data
(60) Provisional application No. 61/247,837, filed on Oct. 1, 2009.

(51) Int. Cl. H04W 12/06; H04W 4/26

(52) U.S. Cl. 455/406; 455/411

(57) ABSTRACT

Described are methods, devices, and systems to provide enhanced wireless coverage for wireless mobile stations by facilitating centralized authentication for a variety of unrelated networks. The mobile stations can then access Internet and telephony resources via the various networks for improved coverage and bandwidth. Some embodiments support the extension of network coverage using wireless-access points that can be partitioned into multiple virtual access points, one associated with an enterprise and another with an overlay network that facilitates mobile communication over multiple networks. One physical access point can support an enterprise network using one virtual access point and the overlay network using another. Users unaffiliated with an enterprise can access the overlay network via the enterprise's physical access point without gaining access to the enterprise network.

### TECHNICAL FIELD

The subject matter disclosed herein relates generally to networks that provide connectivity between mobile stations and information resources available via the Internet.

### BACKGROUND

Providing satisfactory wireless service, in terms of both coverage area and bandwidth, is very challenging. After decades of enhancement and generations of technologies, wireless carriers continue to expend considerable resources improving coverage and capacity. Despite these efforts, the gaining popularity of smart phones and portable computers (mobile stations) is outpacing the ability of wireless carriers to satisfy consumer demand for increased wireless coverage and bandwidth.

Many modern smart phones include wireless support for communicating both with cellular base stations and wireless access points (WAPs) associated with local networks, such as Wireless Local Area Networks (WLAN). In comparison with cellular base stations, WAPs generally offer greatly increased bandwidth but smaller, more targeted coverage. Users can therefore employ WAPs (e.g., WiFi networks, or “hotspots”) when they are available, and rely upon cellular infrastructure elsewhere. For example, coffee shops often install WAPs to attract customers drawn to inexpensive, high-bandwidth, Internet access. Customers can use these available WAPs to access their home and work networks, or to access Internet information resources.

Many homes, businesses, and government entities provide WAPs. These WAPs generally require users to authenticate their mobile stations before gaining network access. Authentication typically involves a sign-on process that is handled by an authentication server within or accessible to WAP. Different WAPs require different authentication procedures. Because of that, moving between WAPs poses a great inconvenience to the user. Even open networks that waive authentication requirements can be problematic, as they typically require the user acknowledge terms and conditions before commencing a data session. The need to seek and receive authorization for each disparately owned and controlled WAP is inconvenient and prevents seamless movement between networks. More importantly, when a user moves from one wireless network to another, the session is discontinued. The lack of session continuity when moving between networks is undesirable, as it can result in disconnection of an engaged session, dropped calls, and other service interruptions.

Some wireless carriers have improved the user experience by distributing ancillary WAPs that supplement their cellular networks. Such a system can allow for an integrated authentication procedure, and consequently facilitate switching between access points. Unfortunately, the number of WAPs is very limited and session continuity may not be assured, or such a solution is limited to a single carrier network. There is therefore a need for methods and systems that support improved wireless coverage, bandwidth, and session continuity for mobile stations.

### BRIEF DESCRIPTION OF THE DRAWINGS

The subject matter disclosed is illustrated by way of example, and not by way of limitation, in the figures of the accompanying drawings and in which like reference numerals refer to similar elements and in which:

FIG. 1 depicts a network system 100 by which a mobile station 105, such as a cellular phone or personal digital assistant (PDA), accesses an Internet information source 110, such as a database serving hypertext documents or an email server;

FIG. 2 depicts a portion of overlay network 137 of FIG. 1 in accordance with one embodiment.

FIG. 3 is a flowchart 300 depicting a method by which OCU 146 authenticates a user's mobile station to establish a cellular path between mobile station 105 and information source 110.

FIG. 4 is a block diagram of an embodiment of ICU 147 of FIG. 1.

FIG. 5 is a flowchart 500 depicting a method by which ICU 147 establishes a WLAN path between mobile station 105 and information source 110 to replace or supplement a cellular connection.

FIG. 6 is a block diagram of mobile station 105 in accordance with one embodiment.

FIG. 7 depicts aspects of a mobile station 700 in accordance with one embodiment.

FIG. 8 depicts a mobile station 800 similar to mobile station 700 of FIG. 7, with like-identified elements being the same or similar.

FIG. 9 depicts a mobile station 900 similar to mobile station 700 of FIG. 7, with like-identified elements being the same or similar.

FIG. 10 is a block diagram 1000 illustrating a tunneling configuration for application to a stream of application data in accordance with one embodiment.

FIG. 11 is a block diagram 1100 illustrating a tunneling configuration in accordance with an embodiment that employs Layer 3—the IP layer—for tunneling.

FIG. 12 is a flowchart 1200 outlining the operation of a traffic-switching algorithm for embodiments in which a mobile station and related ICU network support two interfaces, such as WiFi and cellular interfaces.

FIG. 13 illustrates a system 1300 in which a mobile station 1305 intercepts and tunnels a data stream from an ICU 1310 at the application layer.

FIG. 14 illustrates a system 1400 in which a mobile station 1405 intercepts a data stream at the kernel layer and tunnels the data stream to an ICU 1310 at the application data layer.

FIG. 15 illustrates a system 1500 in which a mobile station 1505 intercepts a data stream at the kernel layer and tunnels the data stream at the network data layer.

FIG. 16 illustrates a system 1600 in which a mobile station 1605 intercepts a data stream at the interface layer and tunnels the data stream at the network data layer.

FIG. 17 depicts a network system 1700 in accordance with another embodiment.

FIG. 18 is a block diagram of a network 1800 that includes overlay network center 140 of FIGS. 1 and 17 connected to a pair of split networks 1805 and 1810, each of which is divided into two virtual networks.

FIG. 19 depicts a WAP 1900 split into multiple virtual access points in accordance with one embodiment.

FIG. 20 depicts a WAP 2000 split into multiple virtual access points in accordance with another embodiment.

FIG. 21 is a block diagram of a WAP 2100, an embodiment of WAP 1705 of FIG. 17.

FIG. 22 illustrates an embodiment of an AP 2200 in which is instantiated two virtual AP instances VAP1 and VAP2 on virtualized platforms.

### DETAILED DESCRIPTION

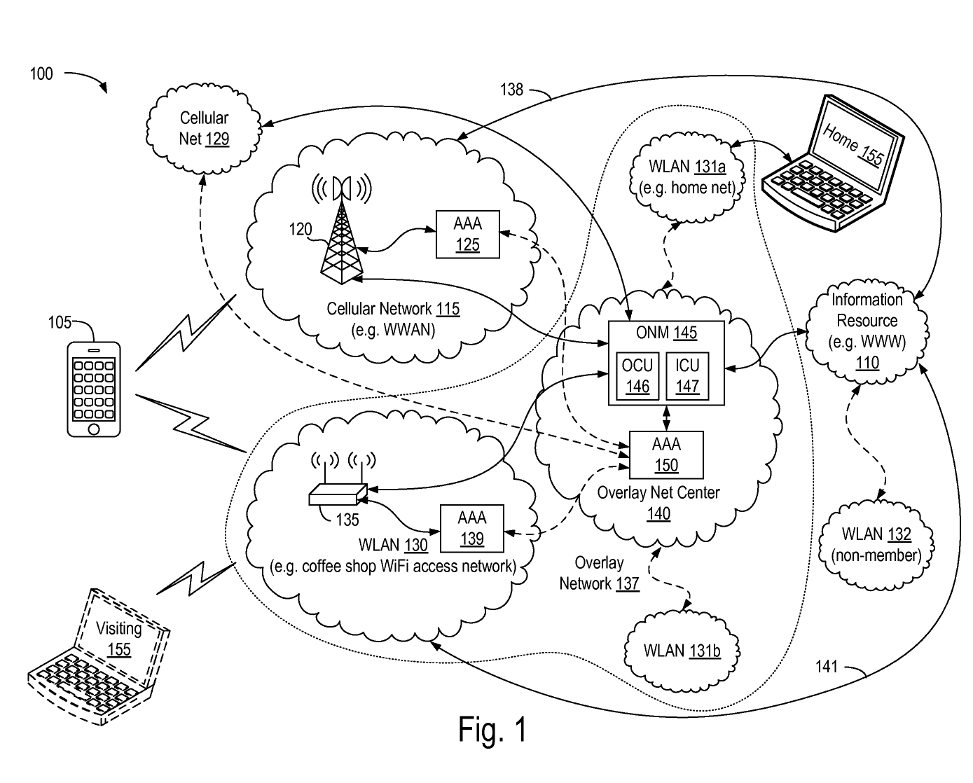

FIG. 1 depicts a network system 100 by which a mobile station 105 accesses an Internet information source 110, such as a database serving hypertext documents or an email server. In this example, mobile station 105 is a mobile communication device, such as a cellular phone, personal digital assistant (PDA), or a laptop or tablet computer, that belongs to a user who has an account with a cellular service provider that maintains a cellular network 115, or a wireless wide-area network (WWAN), which conventionally includes cellular towers 120 and an AAA server 125.

AAA server 125 is so named because it provides authentication, authorization, and accounting. Cellular towers 120 provide for wireless communication between mobile station 105 and cellular network 115, while AAA server 125 controls which mobile stations 105 have access to network 115, what level of service they receive, etc. System 100 additionally includes a second cellular network 129 and a number of wireless local-area networks (WLANs) 130, 131, and 132. Each WLAN provides for wireless communication over an area that is limited relative to what is typically provided by cellular networks 115 and 129. In this example each WLAN is independently managed by e.g. a homeowner or enterprise. Enterprise WLANs are generally used to interconnect various company sites (production sites, head offices, remote offices, shops etc.), allowing employees to share computer resources over the network. The networks depicted as clouds in FIG. 1 can be interconnected with one another and with other networks using proprietary connections or public resources, such as the Internet.

WLAN 130 is a network, such as an access network in a coffee shop or a campus-wide access network, that includes a wireless access point (WAP) 135 and an AAA server 139. WLAN 130 can communicate with mobile station 105 using a different air interface than that employed by cellular network 115. Compared to cellular network, WLAN typically provides considerably higher data bandwidth and lower cost per byte of information, albeit within a much smaller coverage area.

Mobile station 105 can access information source 110 via any network for which mobile station 105 has the requisite access privileges to satisfy the AAA server of the corresponding network. AAA servers are well known, so a detailed discussion is omitted. Briefly, the first “A” stands for authentication, which refers to the process of verifying a device's claim to holding a specific digital identity, and typically involves providing credentials in the form of passwords, tokens, digital certificates, or phone numbers. The second “A” is for authorization, and is more properly termed “access control.” This functionality grants or refuses access privileges. For example, a WLAN may grant a given mobile station access to the Internet but deny access to a proprietary database. Finally, the last “A” is for “accounting,” which refers to the tracking of the consumption of network resources, typically for purposes of billing. AAA servers are alternatively referred to herein as “authentication” servers, as some embodiments may dispense with other functionality.

Commercial or non-commercial entities that offer wireless network access to mobile stations are referred to herein as “service providers.” In the example of FIG. 1, a cellular communications company is a commercial service provider that offers wireless network access via respective cellular network 115. When a service provider has more than one network (e.g., a service provider controls both cellular network 115 and WLAN 130), moving between these networks can be relatively simple. If, for example, the user of mobile station 105 is authorized access to cellular network 115, and WLAN 130 is controlled by the same service provider, the AAA server 139 in the WLAN 130 can authenticate mobile station 105 by sharing information with AAA server 125 over a network connection, such as via a dedicated internal connection or the Internet.

The vast majority of networks are not controlled by a single service provider, however. For example, a user of mobile station 105 may subscribe to a cellular service that controls network 115, but does not provide access to resources within a second cellular network 129. Such a mobile device would thus be prevented from moving between networks 115 and 129. Similarly, a subscriber to cellular network 115 may require separate authentication to gain access to WLANs 130. Some enterprises charge fees for WLAN access, or at least require a password. Even where access is free and a password is omitted, enterprises often require users to accept some form of agreement not to misuse the WLAN. These authorization procedures make it difficult to move seamlessly between separately authenticated networks.

According to an embodiment, system 100 includes an overlay network 137, which in turn includes an overlay network center 140, a WLAN 130 (e.g., associated with a coffee shop), and WLANs 131a and 131b. In this embodiment, WLANs 130, 131a, and 131b are members of overlay network 137 in the sense that they are administrated by an overlay network center 140 and are accessible to devices that subscribe to overlay network 137. Overlay network center 140 supports a common authentication scheme to allow mobile station 105 access to information source 110 via any of the member networks of overlay network 137. Another WLAN 132 represents a non-member network that is outside of overlay network 137, as opposed to those (130 and 131) for which overlay network center 140 provides authentication.

Each of cellular networks 115 and 129 requires authentication separate from overlay network 137, and include a gateway server (not shown) that controls traffic and routing within the range of addresses assigned to components of the network. This separate control of traffic and routing places networks 115 and 129 outside the overlay network 137. Agreements between the enterprises controlling the cellular and overlay networks can nevertheless allow subscribers to the cellular networks access to overlay network 137 either via their respective cellular networks or member networks of overlay network 137. Cellular networks can be within overlay network 137 in other embodiments, in which case AAA server 150 may provide authentication for access to both cellular and local-area networks within overlay network 137.

In one embodiment, overlay network center 140 includes an overlay control unit (OCU) 146, an interworking control unit (ICU) 147, and an AAA server 150. OCU 146 uses AAA server 150 to manage user authentication for each member network within overlay network 137, and for external networks that provide the requisite authentication information. In the embodiment of FIG. 1, cellular network 115 is administered separate from overlay network 137, and requires separate authentication for access. An arrangement between the administrators of cellular network 115 and overlay network 137 can allow users authenticated for access to cellular network 115 to be authenticated for access to overlay network 137. For example, cellular network 115 can authenticate mobile station 105 for access to network 115, and this authentication can be extended to overlay network 137 to allow station 105 access to overlay network 137 either via network 115 or one of member networks (e.g., WLAN 130). OCU 146 thus facilitates network access over a wide coverage area and ease of movement between the member networks.

OCU 146 includes a gateway server (not shown) that controls traffic and routing within the range of addresses assigned to components of overlay network 137. OCU 146 allows mobile stations to maintain session continuity while moving between member networks and authorized non-member networks, such as cellular network 115. ICU 147 manages data traffic, e.g. between mobile station 105 and source 110, in a way that optimizes use of member and authorized non-member networks that provide overlapping coverage areas. For example, when a mobile device is authorized to access more than one network covering a given location, ICU 147 may select the network or networks that provide the best security, price, speed performance, etc. This selection may be based on user preferences, network capacity, mobile-device capability, the nature of the network traffic, or a combination to these and other parameters.

Cellular network 115 may be a member network in other embodiments, but would likely require separate authentication. In this example, cellular network 115 allows authenticated mobile stations to separately authenticate with overlay network 137 via network 115. Customers of cellular network 115 may therefore access source 110 via cellular network 115 or any member network of overlay network 137.

Consider the example in which a subscriber to cellular network 115 is in the coffee shop that maintains member network 130. If the subscriber does not also subscribe to overlay network 137, the user's mobile station 105 can nevertheless gain access to source 110 using either cellular network 115 or WLAN 130, via respective paths 138 and 141 outside of overlay network 137. The user would choose between these options, and user mobile station 105 would require some level of authentication for each. Separate authentications, if available, would allow the user to likewise access source 110 via any network with an Internet connection. However, the need for separate authentications makes it difficult for the user to transition between networks.

Now assume the user's cellular service provider has a business relationship with the service provider that administers overlay network center 140, and that this relationship allows the user to access overlay network 137. Should the user seek access to information source 110 from the coffee shop, that access could be provided via WLAN 130, cellular network 115, or both. Where more than one network is available, ICU 147 can decide upon a path between mobile station 105 and the requested resource 110 based on general or user-specific preferences. In the coffee-shop example, the user might prefer to use WLAN 130 for lower cost or improved speed performance, and to use cellular network 115 for secure communications. In other embodiments, the decision regarding which path or paths to take between mobile station 105 and the requested resource can be made by the mobile station (e.g., 105 or 155) and communicated to ICU 147.

Information source 110 is called an Internet information resource, but is not to be confused with the Internet. The Internet is a global system of interconnected networks that use a standardized Internet Protocol Suite (TCP/IP). Cellular network 115 is not likely part of the Internet, but one or more of WLANs 130 may well be. In addition, the cellular network and WLANs can be connected to one another and to other resources via Internet connections, which may include copper wires, fiber-optic cables, or wireless connections. Internet information resources are not this network infrastructure, but are in this context the types of information carried by the Internet. Such information includes the inter-linked hypertext documents of the World Wide Web (WWW), electronic mail, VOIP data, and streaming multimedia data.

Overlay network center 140 can be controlled by a different service provider than those that control networks 115 and 130. The user of mobile station 105 might subscribe to Internet access via his or her cellular service provider. The cellular service provider can then provide access to the Internet directly, e.g. via path 138, or can provide access from cellular network 115 by way of overlay network 137. In the latter case, mobile station 105 is authenticated by AAA server 125 for access to cellular network 115, and is authenticated by AAA server 150 for access to overlay network 137. Once set up with the cellular service provider, these authentications can be transparent to the user, and will thus not interfere with the user's experience.

Different types of networks can be used together for their respective benefits. For example, sensitive information may be communicated over a relatively secure cellular network while less sensitive information is simultaneously conveyed to the mobile device over a less secure but higher bandwidth LAN.

Subscribers of overlay network 137 attempting to gain access to overlay network 137 via any member network have their mobile stations 105 authenticated by AAA server 150 rather than the AAA server of the accessed member network. WLAN 130 includes an AAA server 139, for example, and gaining access to overlay network 137 via WLAN 130 may require authentication via either AAA server 139 or AAA server 150. Overlay network center 140 thus centralizes authentication among the multiple wireless networks to allow mobile station 105 to move freely between wireless networks. Overlay network center 140 also anchors data sessions between mobile station 105 and information resources outside of the member networks to maintain communication as mobile station 105 moves between wireless networks.

In some embodiments one or more of WLANs do not separately authenticate mobile station 105, but instead rely entirely on overlay network center 140 for authentication. In other embodiments AAA server 139 is used to authenticate devices for access to information sources local to WLAN 130, but is bypassed for connections outside the WLAN, such as to the Internet.

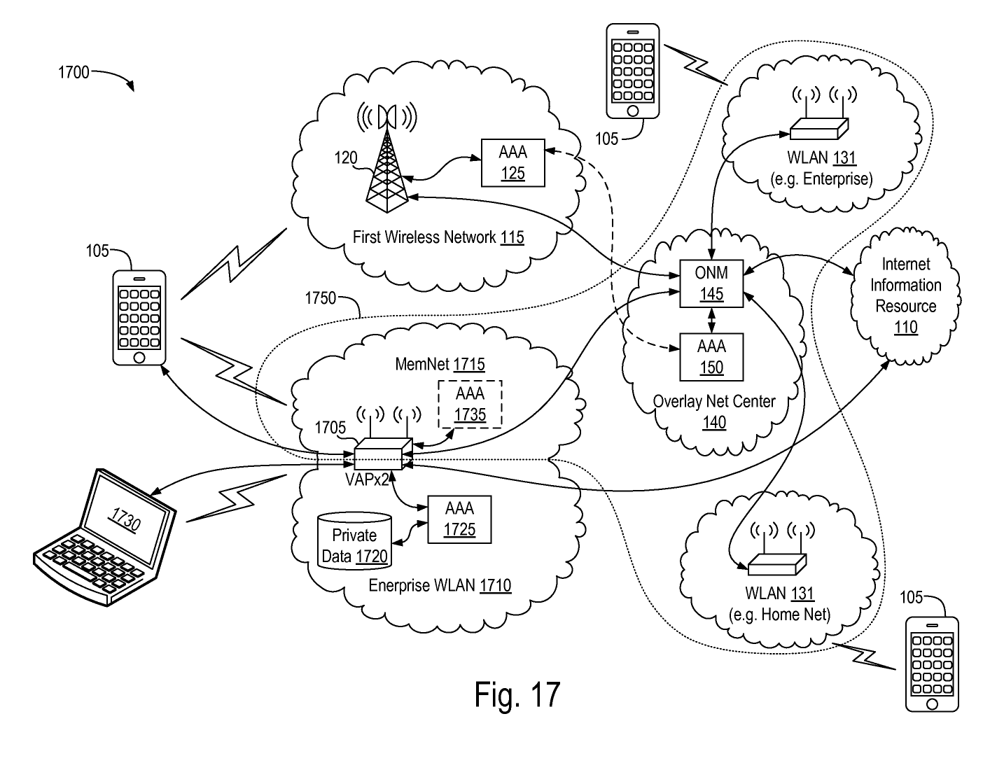

In this example, a laptop computer 155 is shown connected to the upper-right WLAN 131, and is assumed to be a member of that WLAN, and by extension a member of overlay network 137. Being a “member” simply means that laptop computer 155 is authorized to access resources within the network. As a member of overlay network 137, a user of computer 155 can access information source 110 from any of member networks 130 and 131, as determined by AAA server 150. As detailed below in connection with FIG. 17, the same or separate access credentials may also allow mobile stations access to private information on any of the member networks from any other network configured to work with overlay network center 140. For example, overlay network center 140 can authorize computer 155 to access information on a user's personal home network via WLAN 131 from coffee-shop enterprise network 130. Such access permissions can be handled by AAA server 150 alone, or by AAA server 150 working in connection with an AAA server (not shown) at the user's personal WLAN 131. In the example of FIG. 1, a dashed version of computer 155 at the lower left represents the computer 155 visiting an enterprise network away from the computer's home network at the upper right. Overlay network center 140 can authenticate the visiting computer 155 to access the home network WLAN 131 at the upper right, information source 110, or both.

System 100 allows the disparate owners of cellular network 115 and WLANs 130 to maintain security over their respective networks, but also requires them to turn over some access control to AAA server 150 of overlay network center 140. Many wireless operators, especially WLAN access providers, will be motivated to share and relinquish some access control to a third party because they can better support their subscribers without jeopardizing the security of their proprietary networks.

While shown as a single entity, AAA server 150 may represent separate AAA servers for OCU 146 and ICU 147. AAA server 150 can be connected to cellular network 115 directly or via one or both of OCU 146 and ICU 147. In its capacity as an interworking authentication server for ICU 147, for example, AAA server 150 can communicate with AAA server 125 of cellular network 115 either directly or via ICU 147.

Each of the devices and networks of FIG. 1 can include many components that have been omitted from FIG. 1 for ease of illustration. For example, mobile station 105 can be a so-called “smart phone” that includes an application/media processor and associated memory to support web access, location-based services, multimedia applications, etc. Mobile station 105 can also include numerous interfaces in support of wireless or wired communications, which commonly include a cellular interface, an infrared port, a Bluetooth wireless port, and a Wi-Fi wireless network connection. Mobile station 105 may also include a Global Positioning System (“GPS”) receiver. Cellular network 115 is likewise far more complex then shown, and will typically include e.g. a Radio Access Network (RAN), which typically includes base stations and controllers, and a Core Network (CN), which typically includes multiple switching entities and gateways. These and other features of mobile station 105 and cellular network 115 are well known to those of skill in the art. A detailed treatment is therefore omitted for brevity.

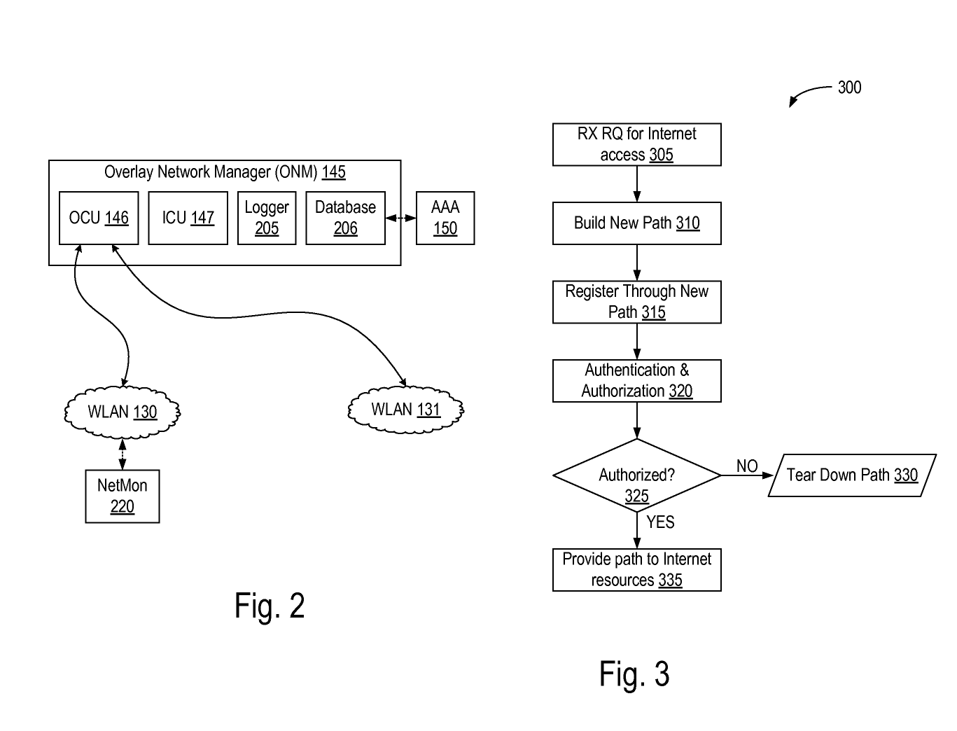

FIG. 2 depicts a portion of overlay network 137 of FIG. 1 in accordance with one embodiment. In addition to the above-described OCU 146 and ICU 147, ONM 145 includes a database 200 and a logger 205. As noted previously, OCU 146 uses AAA server 150 to authenticate users of the overlay network. Briefly, when a mobile station requests access to the overlay network via one of the member networks, AAA server 150 authenticates or denies the mobile station, usually by verifying its possession of certain secret information, such as a password or an encryption key. If the authorization request comes to AAA server 150 by way of WLAN 130, for example, AAA server 150 instructs that member network whether to grant service, and possibly at what level of service. WLAN 130 and other member networks might be configured to report usage statistics to AAA server 150 for e.g. accounting purposes.

OCU 146 may be used by the operator of overlay network 137 to monitor and manage overlay network 137 (FIG. 1), and may also provide some level of control to operators of member networks that allows them to monitor and manage connections, user profiles, billing, etc. As is common for access networks, OCU 146 may track data and log events to satisfy legal requirements and prevent and trace illegal network activities and attacks. ONM 145 includes a database 206 to store whatever data is required for the overlay network to manage access for member networks and overlay-network subscribers.

Different levels of monitoring and logging are possible depending on the network configuration and requirements. AAA server 150 can track subscriber logins and traffic; alternatively or in addition, member networks can track logins and traffic and report this information to AAA server 150. Such tracking can be done by logging at Layer 3 and Layer 2 traffic based on TCP sessions or source and destination IP address of the IP packets. The term “Layers” refers to the layers in OSI model (Open System Interconnection Reference Model).

The OSI model is well known to those of skill in the art, so a detailed treatment is omitted for this disclosure. Briefly, the OSI model is a model for connecting computers together in a network. The model consists of seven distinct and separate layers of protocols; namely, a physical layer (1), a data link layer (2), a network layer (3), a transport layer (4), a session layer (5), a presentation layer (6), and an application layer (7). The layers that are of concern to us are Layer 1 through 4. Layer 1, the physical layer, physically transmits data between network nodes. Layer 2, the data link layer, handles the link protocols that transfer data between adjacent network nodes. Data that are transmitted on Layer 2 are usually link layer data frames (e.g., Ethernet data frames). Layer 3, the network layer, handles end-to-end data delivery, including tasks such as host addressing, packet manipulation and routing. The data that are transmitted on Layer 3 are usually IP (Internet Protocol) packets. Layer 4, the transport layer, is a group of methods and protocols that encapsulate application data blocks into data units (datagrams, TCP segments) suitable for transfer, or managing the reverse transaction by abstracting network datagrams and delivering their payload to an application. Layers 5, 6, and 7 are often called the “application layers.”

ONM 145 is communicatively coupled to a network monitor 220 via a member network, WLAN 130 in this example. Monitor 220 may assign dynamic IP addresses to mobile stations when requested. In such cases, IP packet tracking tracks the activity to a certain dynamic IP address, and additional information is used to map the dynamic IP address to individual user. Dynamic IP address are assigned using DHCP (Dynamic Host Configuration Protocol) by a DHCP server (not shown), which may record the event of the assignment of dynamic IP addresses. Such a DHCP server may listen for DHCP requests, assign addresses to the requesters, and record the events to corresponding event loggers in the overlay network.

Monitor 220 may also record address assignments to logger 205, and can monitor the overlay network for the presence of subscriber's mobile stations. In such cases, the detachment of a mobile station is usually not signaled. For example, a mobile station may move outside a wireless coverage area, or may be disabled by a user (e.g., the user may close or power down a laptop). Monitor 220 may therefore monitor the status of connected mobile stations with assigned IP addresses to detect detachment. For example, Layer 2 may be set up to periodically check for presence of mobile stations. This may be done in a variety of other ways, such as wireless signal sensing. Where monitor 220 is part of a member network, the administrator of the member network may have control over configuration and management. Implementing monitor 220 as user device with a wired or wireless connection to a member network can simplify deployment. In that case, monitor 220 may have a static IP address. The monitor can then communicate with ONM 145 via the member network(s), and can be remotely managed by way of these connections.

OCU 146, using AAA server 150, can authenticate users' mobile stations using different network layers. Authentication may take place at Layer 2 (Data Link Layer) or Layer 3 (IP Layer), for example. Though shown as a single AAA server 150, the authenticator and authentication server can be at different network nodes. For example, a wireless access point associated with one of the member networks can control access to the overlay network using authentication information within AAA server 150.

An authentication process in accordance with one example of the embodiment of FIG. 2 proceeds as follows: a user, by way of a mobile station, connects to a wireless access point 135 (the authenticator) of WLAN 130 and requests access to overlay network 137; WLAN 130 builds a connection to AAA server 150 (the authentication server) and relays messages between the mobile station and AAA server 150; After verifying the user's credentials, AAA server 150 relays the authentication results back to WLAN 130; and based on these results WLAN 130 may deny the mobile station access or grant some level of access to overlay network 137.

FIG. 3 is a flowchart 300 depicting a method by which OCU 146 authenticates a user's mobile station to establish a cellular path between mobile station 105 and information source 110. For this example, mobile station 105 is assumed to have been authenticated by AAA server 125 and in communication with cellular network 115, and mobile station 105 has requested access to information source 110 on behalf of mobile station 105. For example, mobile station 105 may automatically or when instigated by the user, request email, stock quotes, news, or any of myriad other types of information available via the Internet.

At step 305, AAA server 150 receives a query from AAA server 125 notifying overlay network center 140 of the user's request for Internet access. Overlay network center 140 then communicates with mobile station 105 to build a path between ICU 147 and mobile station 105 (step 310) and registers the new path (step 315). With the path thus established, AAA server 150 communicates with mobile station 105 to authenticate mobile station 105 and authorize the Internet connection (step 320). Per decision 325, if the authentication is unsuccessful then the ONM 145 tears down the newly created path (step 330). If successful, however, ONM 145 establishes and maintains a path between mobile station 105 and the requested information resource via cellular network 115 (step 335). ONM 145 remains a network anchor point for the data path between mobile station 105 and information source 110 until mobile station 105 or network 115 releases the connection.

Separating the authenticator from the authentication server can be advantageous. This separation allows an overlay network to aggregate access among disparate entities and via multiple access providers (e.g. member networks 130 and 131). Furthermore, the system can be designed so that the credential verification process between the user's mobile station and the authentication server (the AAA server) is encrypted and protected. In such cases the access point need not have access to user credentials or other forms of confidential information, which makes it easier for the authenticator and AAA server to be controlled by separate entities.

Because the authenticator has access to messages between the mobile station and AAA server 150, care should be exercised to prevent any playback or Man-in-Middle attacks. Standard security practice should be followed, for example using a good random number generator. Extensible Authentication Protocol (EAP) framework can be employed when authentication is performed at Layer 2. The EAP framework is detailed in e.g. B. Aboba, L. Blunk, J. Vollbrecht, J. Carlson, and H. Levkowetz, Ed., “Extensible Authentication Protocol (EAP)”, Internet Engineering Task Force RFC 3748 (Standard Track), June 2004.

Over the local wireless network, the EAP exchange may be carried over IEEE 802 through “EAP over LAN” (EAPOL) IEEE 802.1x, which is detailed in “IEEE Standard for Local and metropolitan area networks, Port-Based Network Access Control,” IEEE Std 802.1X-2004, December 2004. Over the external network, the EAP exchange may be carried over Remote Authentication Dial In User Services (RADIUS) through RADIUS Support for EAP following the common practice guidelines. RADIUS is detailed in C. Rigney, S. Willens, A. Rubens, and W. Simpson, “Remote Authentication Dial In User Services (RADIUS)”, Internet Engineering Task Force RFC 2865 (Standard Track), June 2000. RADIUS Support for EAP is detailed in B. Aboba, and P. Calhoun, “RADIUS (Remote Authentication Dial In User Service) Support for Extensible Authentication Protocol (EAP)”, Internet Engineering Task Force RFC 3579 (Standard Track), September 2003. Common practice guidelines for RADIUS Support for EAP are laid out in P. Congdon, B. Aboba, A. Smith, G. Zorn, and J. Roese, “IEEE 802.1X Remote Authentication Dial In User Service (RADIUS) Usage Guidelines”, Internet Engineering Task Force RFC 3580 (Standard Track), September 2003.

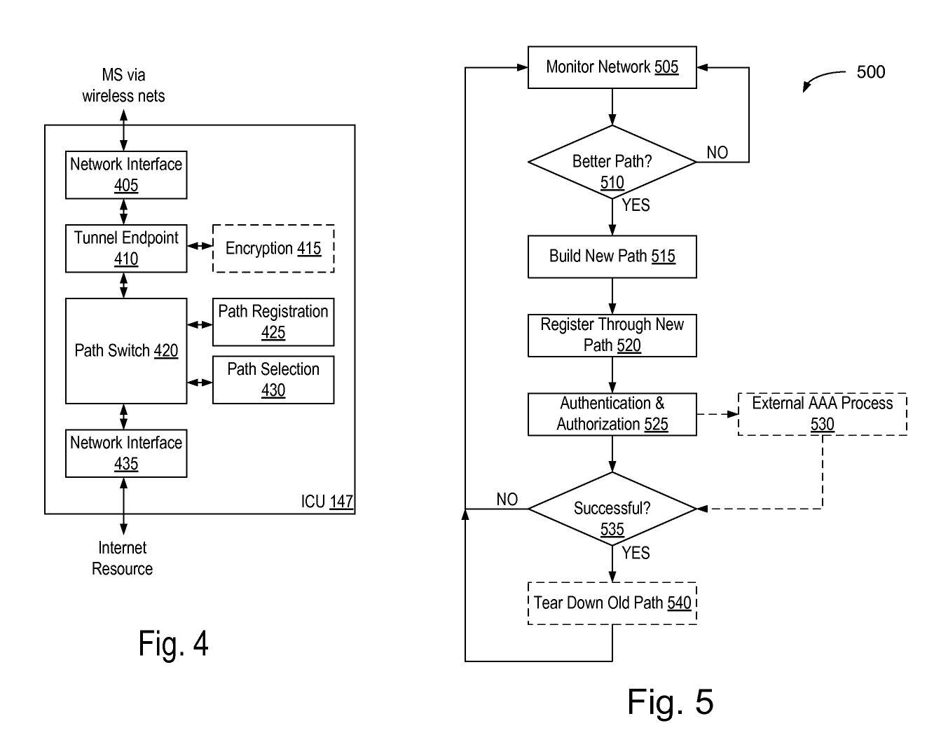

FIG. 4 is a block diagram of an embodiment of ICU 147 of FIG. 1. ICU 147 includes a network interface 405 to communicate with mobile station 105 via one or more defined communication paths. A tunnel endpoint 410 ensures the integrity of data passed between ICU 147 and mobile station 105. In a packet-switched network, endpoint 410 buffers and reorders packets, checks for errors, and requests retransmission as necessary. These actions are conventional, and the list of actions is not exhaustive. ICU 147 may additionally support encryption/decryption functionality 415 to provide secure connections.

A path switch 420 manages data flow for one or multiple paths defined between ICU 147 and mobile station 105. Path switch 420 is controlled by path registration block 425 and path selection logic 430. Path registration block 425 stores information used to define the path or paths. Path selection logic 430 includes information upon which ICU 147 bases decisions regarding path preferences. Path selection logic 430 may be programmed, for example, to achieve a desired minimum bandwidth or to achieve a maximum Internet bandwidth without exceeding a specified cost-per-byte. Whatever paths are specified, a second network interface 435 manages communication with the Internet information resource.

More complex selection trade-off can be implemented on the system level (for example, to optimize the system load). For example, ICU 147 can implement an algorithm that seeks to balance system capacity. When more than one network interface is available for a giver user's device, and the requisite system-load information is available, ICU 147 may choose to connect to that mobile station in a way that optimizes the overall macroscopic system load. If, for example, an overlay network supports cellular and WiFi networks, the ICU may opt to used an available cellular connection for a requesting mobile station should the WiFi network be oversubscribed, or vice versa.

FIG. 5 is a flowchart 500 depicting a method by which ICU 147 establishes a WLAN path between mobile station 105 and information source 110 to replace or supplement a cellular connection. This example assumes the existence of a prior cellular connection as discussed above in connection with FIG. 2.

ICU 147 monitors for alternative channels (step 505). In this context, a channel is a physical interface, which may be wired, wireless, or a combination of the two. For example, mobile station 105 may monitor the local environment for additional wireless networks and alert ICU 147 if a better connection becomes available. With a cellular connection in place, ICU 147 may simply maintain that path until a user's mobile station enters the service area for a WLAN. Per decision 510, if a better path becomes available via e.g. one of WLANs 130, ICU 147 works with mobile station 105 to build a new path through the respective WLAN 130 (step 515) and to register the new path (step 520). With the path established, AAA server 150 communicates with mobile station 105 to authenticate mobile station 105 and authorize the Internet connection (step 525). If the authentication is successful, then per decision 535 AAA server 150 authorizes ONM 145 to establish a connection between mobile station 105 and information source 110 via the respective WLAN 130. In some embodiments, as indicated in step 530, WLAN 130 does not have or rely upon AAA server 139, but instead relies solely on AAA server 150 for authentication and related services. Once a new path is in place, ICU 147 optionally tears down the old path, a cellular path in this example (step 540), and continues to monitor for better paths. Other WLAN and cellular networks can likewise be used separately or in combination with existing paths to provide a desired bandwidth, coverage area, or cost structure.

ICU 147 monitors for paths and communicates with mobile station 105 to determine whether an identified path is preferred over another in the foregoing example. This monitoring and the decision to switch may be also be accomplished by a collaboration between ICU 147 and mobile station 105. This decision may also involve e.g. cellular network 115, as where a user's mobile access is governed by an agreement with the cellular provider. The path selection algorithm and criteria may be based on e.g. signal strength, traffic patterns, power constraints, cost-per-byte, and battery status.

Path selection may be further individualized for each application or for each traffic class. The data traffic, even when from one mobile station, may be of many different characteristics. Security is paramount for some applications (e.g., banking or database applications), while bandwidth is more important for others (e.g., video download applications). Still other applications require stability and short transmission delays (e.g., IP telephony applications). Embodiments of the mobile stations and ICUs disclosed herein can control for these characteristics using algorithms sensitive to these and other communication characteristics. For example, when a mobile station has more than one available connection, the algorithm may direct data traffic from different applications into different paths based on the characteristic of the application. These characteristics may include security, bandwidth, delay, jitter, stability, etc. Some embodiments categorize data traffic, rather than application types, to aid in the selection of preferred channels. Classes of data traffic can include secure traffic, real-time traffic, high-bandwidth traffic, etc. Each application may generate traffic that belongs to one or more traffic classes. Alternatively, an algorithm may be based on application characteristic. When more than one channel is available to a given mobile station, the algorithm may direct data traffic from different traffic classes into different paths based on the characteristic of the traffic.

As noted previously, path selection may not be exclusive of a single path. Multiple concurrent paths may be aggregated into a combined pipe used on the same mobile station, to serve the same or different applications, or to serve the same or different traffic classes. In one example a channel-selection algorithm is based on at least one of: the overall bandwidth requirements of a mobile station, an application running on the device, of each application, and the traffic class or classes for the communicating device. In a typical example, a mobile station may select between a cellular wireless interface and a WiFi interface. Of these, the cellular interface offers wider coverage, enhanced security, and high data bandwidths, but at higher cost. The majority of data traffic may be generated by a web-browser application running on the mobile station, in which case a browser on the mobile station may generate secured requests through SSL (Secure Socket Layer) and other unsecured normal requests.

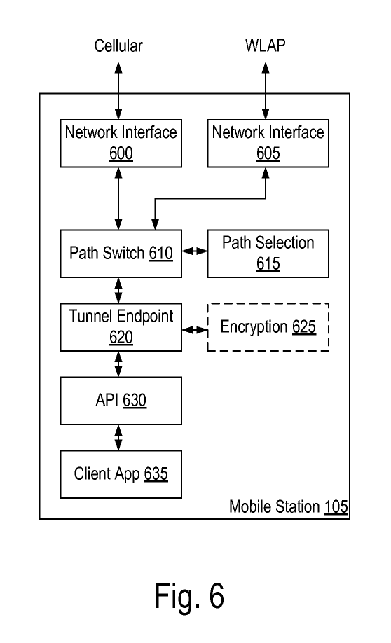

FIG. 6 is a block diagram of mobile station 105 in accordance with one embodiment. Mobile station 105 includes a cellular network interface 600 and a WLAP interface 605. Cellular network interface 600 can support any of the conventional cellular protocols, such as code-division multiple access (CDMA) or High Speed Packet Downlink Access (HSPDA), or may be extended to other conventional or later adopted wireless protocols, such as whitespace radio. Network interface 605 can likewise support conventional protocols, such as WiFi or WiMax, or may be extended to other protocols.

Mobile station 105 additionally includes a path switch 610 and path selection logic 615, which together select one or both interfaces 600 and 605 for communication. A tunnel endpoint 620 ensures data integrity in the manner of tunnel endpoint 620 of FIG. 6, and may likewise include encryption/decryption functionality 625. Finally, an application interface 630 provides a data interface between the tunnel endpoint and a client application 635. In this context, the term “client application” refers to one or more applications executing on mobile station 105 and accessing information on servers remote from the mobile station. Common examples of such client applications include Web browsers, media players, and email applications. Some clients may support algorithms that make decisions about how best use the available interfaces 600 and 605 and corresponding networks. A client may select a connection based on the availability of connectivity, signal strength, the cost of connectivity, security, or a combination of these and other criteria.

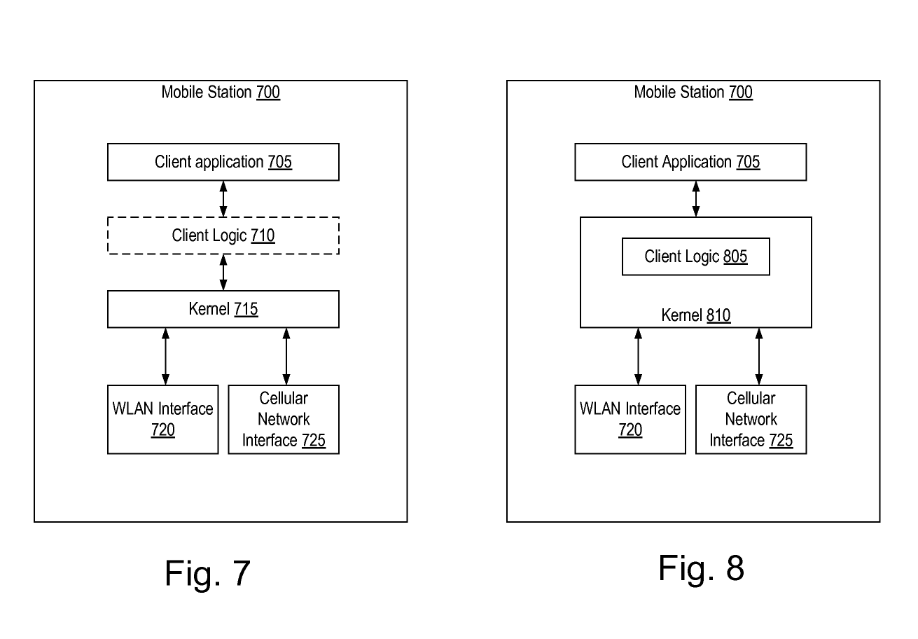

FIG. 7 depicts aspects of a mobile station 700 in accordance with one embodiment. Mobile station 700 supports hardware and software components that control data flow. These include a client application 705, optional client logic 710, a kernel 715, and two network interfaces 720 and 725. In one embodiment, client logic 710 represents the combination of blocks 610, 615, 620, 625, and 630 of FIG. 6. In this example, data is generated at client application 705, likely through interaction between the user and mobile station 700. The data at client application 705 is usually application specific, such as data associated with a request for access to network resources. Client application 705 sends the data to kernel 715 through an interface (not shown) that is usually called the system API (Application Programming Interface). Alternatively, application 705 can use function calls to client logic 710 to perform communication tasks. In that case, client logic 710 intercepts and handles data streams from the application 705 and manages all the issues related to the data traffic offloading between member networks while maintaining session continuity.

Kernel 715 may handle the data by managing the logical data connections, arranging the data queues, communicating the data through hardware devices connected to the mobile station, and making sure that sending and receiving of the data are performed as designed. Kernel 715 communicates with the other network entities through the network interfaces 720 and 725. The other network entities may include base stations, access points, and authentication servers, just to name a few.

When data streams are intercepted at the application layer, client application 705 may have to be rebuilt to use the client API instead of the system API. This application re-building process may be applied to all applications running on mobile station 700 so they benefit from traffic offloading.

FIG. 8 depicts a mobile station 800 similar to mobile station 700 of FIG. 7, with like-identified elements being the same or similar. In station 800, client logic 805 is a component of a kernel 810 to illustrate an example in which data streams are intercepted in the kernel. In this scenario, application 705 uses the system API to access functions provided by kernel 810, and client logic 805 is included within kernel 810 on the path of the data processing. Client logic 805 thus can intercept data streams and manage issues related to the data traffic offloading through ancillary networks, all while maintaining session continuity. Placing client logic 805 within kernel 810 allows applications using the system API to benefit from traffic offloading features provided by the kernel.

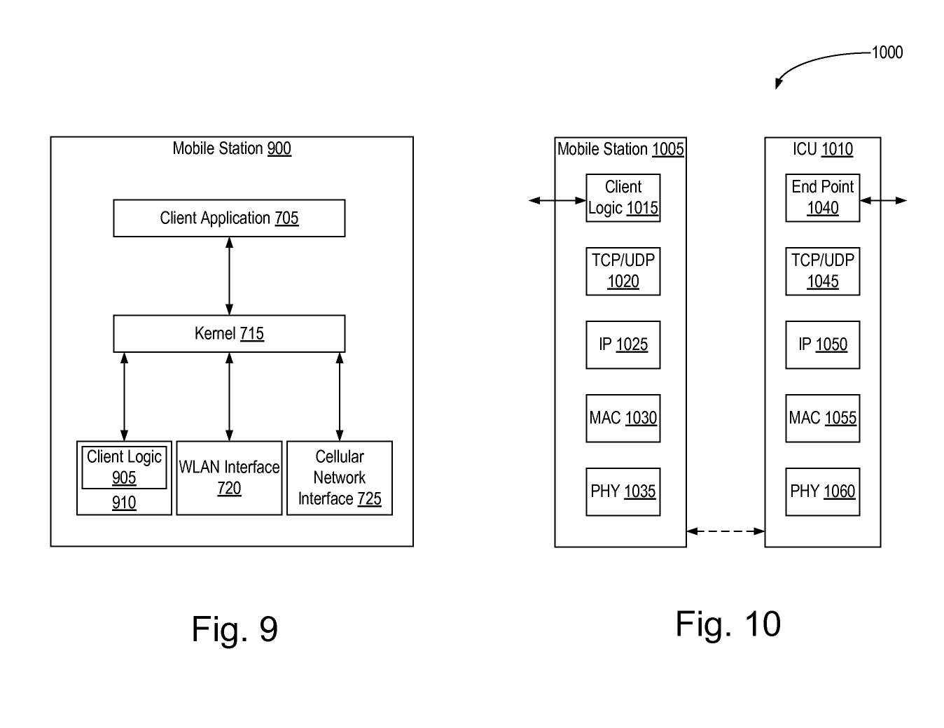

FIG. 9 depicts a mobile station 900 similar to mobile station 700 of FIG. 7, with like-identified elements being the same or similar. Mobile station 900 includes a virtual network interface 910 with virtual device drivers (not shown) that support client logic 905. Client application 705 may be configured to use virtual interface 910 either through direct configuration or as a default for kernel 715. Interface 910 intercepts data streams on mobile station 900 and manages issues related to data-traffic offloading through ancillary networks while maintaining session continuity. Data are ultimately conveyed through physical network interfaces (e.g., WLAN or cellular interfaces 720 and 725).

Data stream interception at station 900 can require the loading of virtual device drivers for client logic 905. There need be no requirement for rebuilding client application 705 or kernel 715. Mobile station 900 and any application or applications 705 may benefit from traffic offloading features provided by virtual interface 910. As in other embodiments, mobile station 900 can thus tunnel intercepted data streams from client logic 905 to ONM 145 (FIG. 1) and vice versa. This can be achieved in multiple ways depending on e.g. where the data is intercepted and how the network is configured.

The concept of tunneling is well known, so a detailed discussion is omitted. In general, tunneling—also called encapsulation—encapsulates data conveyed using one network protocol within packets conveyed using another network protocol. The network protocol used for the communication of the delivery tunnel is called the delivery protocol. The network protocol used for the data that is been delivered, the “payload” being carried within the tunnel, is called the payload protocol. Usually, the tunnels are used to carry payloads over incompatible delivery networks, or to provide a secure path through insecure networks. In the context of the present disclosure, tunneling is used to switch smoothly and transparently between and aggregate among different wireless networks. Tunneling mechanisms in accordance with some embodiments are adapted to work with the data stream interception methods discussed herein.

FIG. 10 is a block diagram 1000 illustrating a tunneling configuration for application to a stream of application data in accordance with one embodiment. This tunneling configuration is generally executed at the application data layer; in contrast, network protocol data is typically executed at other layers, such as Layer 3 or Layer 2.

In FIG. 10, the left-hand side represents a mobile station 1005 and the right-hand side an ICU 1010. Mobile station 1005 supports a protocol stack, including Layer 4 TCP/UDP 1020, Layer 3 IP 1025, Layer 2 MAC 1030, and Layer 1 PHY 1035. A client application 1015 sits above the Layer 4, as this is application-data-layer tunneling. In ICU 1010, the protocol stack is Layer 4 TCP/UDP 1045, Layer 3 IP 1050, Layer 2 MAC 1055, and Layer 1 PHY 1060. A tunnel endpoint 1040 sits above Layer 4 for the application data layer tunneling. Data communicated between station 1005 and ICU 1010 is tunneled between client application 1015 and endpoint 1040. The data stream tunneling at the application data layer as described herein may be used with data-stream interception at the application or kernel, as described previously, or may be used with other interception methods. Tunneling can be executed at different network layers, and data within the tunnels can likewise be of different network layers.

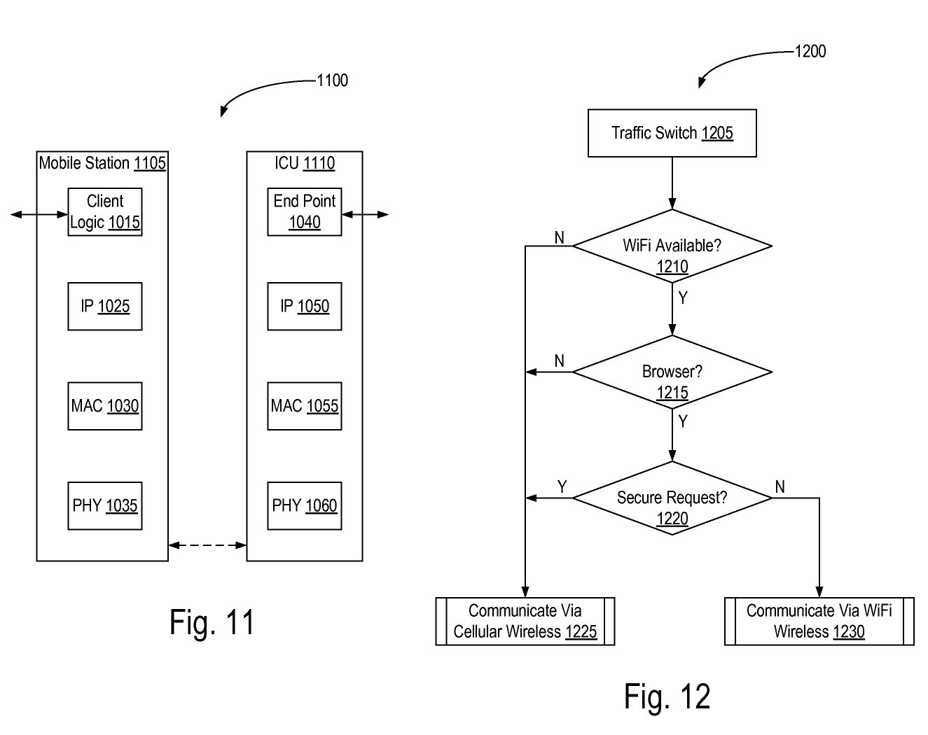

FIG. 11 is a block diagram 1100 illustrating a tunneling configuration in accordance with an embodiment that employs Layer 3—the IP layer—for tunneling. Diagram 1100 is similar to diagram 1000 of FIG. 10, with like-identified elements being the same or similar. In this example, a mobile station 1105 includes a client application 1015 that encapsulates intercepted IP packets and sends them through IP layer 1025, from whence then move through the lower-layer stacks 1030 and 1035. In ICU 1110, tunnel endpoint 1040 is above PHY layer 1060, MAC layer 1055, and IP layer 1050 for the IP tunneling. Data is tunneled between client application 1015 and endpoint 1040. The data stream tunneling at the network layer as described herein may be used with data stream interception at the kernel or mobile station, or may be used with other interception methods.

FIG. 12 is a flowchart 1200 outlining the operation of a traffic-switching algorithm for embodiments in which a mobile station and related ICU network support two interfaces, such as WiFi and cellular interfaces. When a traffic switching algorithm is started at the mobile station (1205), the algorithm determines whether WiFi connectivity is available (1210). If not, then all data traffic is communicated via a cellular wireless channel (1225). If WiFi is available, the algorithm determines whether the data traffic is associated with the browser (1215), rather than e.g. a telephony application. If the data traffic is not associated with the browser, then all data traffic is communicated via the cellular channel.

This example assumes browser traffic, when present, represents the majority of data traffic, and that browser traffic may be designated either as secure or as unprotected. If a given browser request designates secure communication (1220), then data traffic is communicated via cellular wireless 1225. If the request designated unprotected traffic, however, then data traffic is communicated via the less expensive WiFi channel (1230).

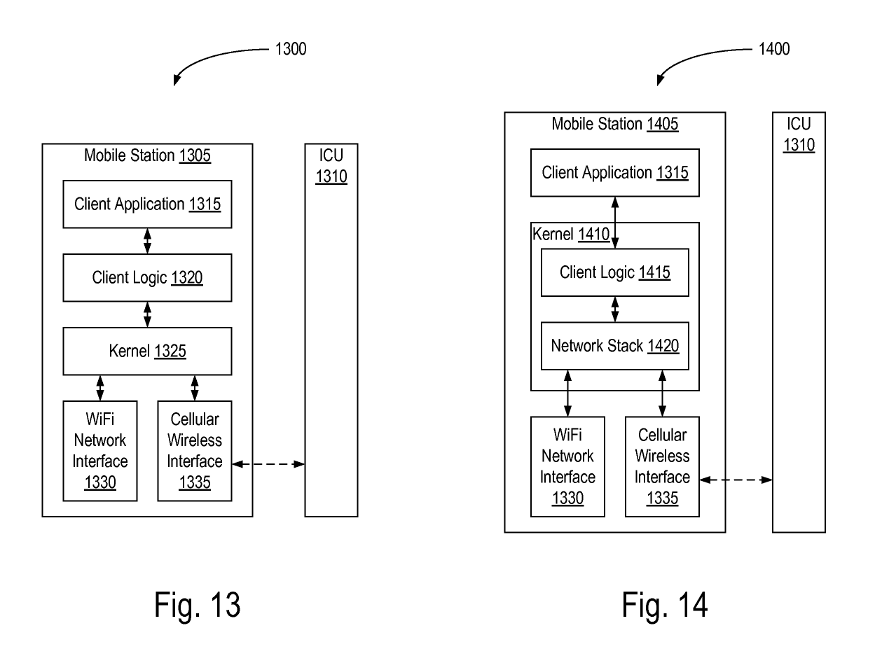

FIG. 13 illustrates a system 1300 in which a mobile station 1305 intercepts and tunnels a data stream from an ICU 1310 at the application layer. In this embodiment, an application 1315 uses function calls to client logic 1320 to perform communication tasks, instead of using e.g. a system API from a kernel 1325. Client logic 1320 intercepts and handles all data streams from application 1315 and builds a tunnel to ICU 1310 for data traffic offloading while maintaining session continuity. The tunnel is built through all the network layers as encompassed in kernel 1325, and through one or both of two wireless interfaces, such WiFi and cellular interfaces 1330 and 1335.

FIG. 14 illustrates a system 1400 in which a mobile station 1405 intercepts a data stream at the kernel layer and tunnels the data stream to an ICU 1310 at the application data layer. System 1400 is similar to system 1300 of FIG. 13, with like-named elements being the same or similar.

In system 1400, application 1315 uses the same system API as in the example of FIG. 13 to access functions provided by a kernel 1410. Client logic 1415, embedded inside kernel 1410, is in the path of the data processing before a network stack 1420 within kernel 1410. Client logic 1415 intercepts and handles all data streams from application 1315, which are still at the application layer before network stack 1420. Client logic 1415 also builds a tunnel to ICU 1310 for data traffic offloading while maintaining session continuity. This tunnel is built through network stack 1420 and through one or both of interfaces 1330 and 1335. Data streams are tunneled at the application data layer, as they enter the tunnel.

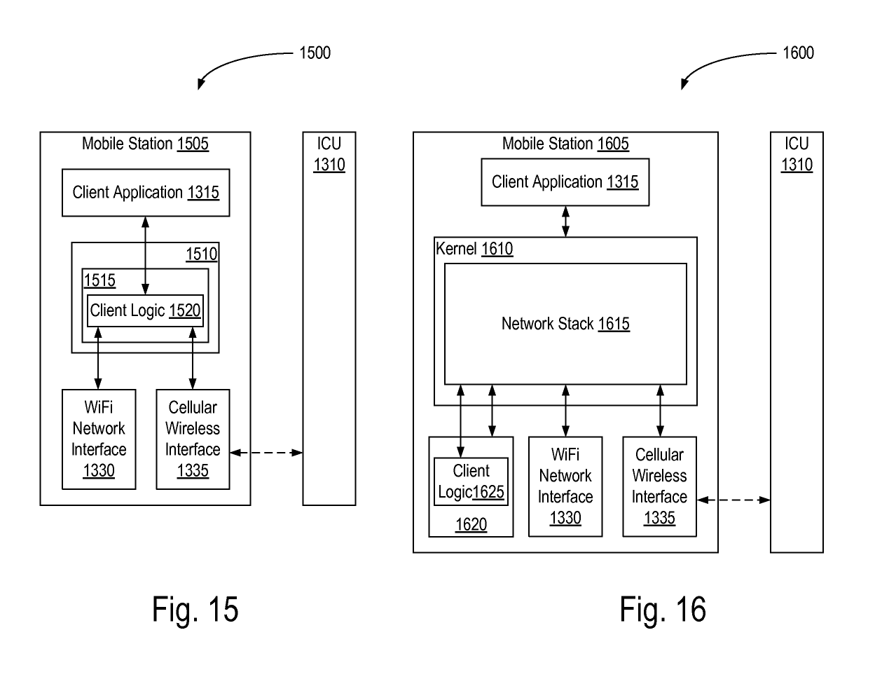

FIG. 15 illustrates a system 1500 in which a mobile station 1505 intercepts a data stream at the kernel layer and tunnels the data stream at the network data layer. System 1500 is similar to system 1300 of FIG. 13, with like-identified elements being the same or similar.

In this embodiment, application 1315 uses the same system API as the embodiment of FIG. 13 to access functions provided by a kernel 1510. Client logic 1520 is embedded within a network stack 1515, which is in turn inside kernel 1510. Client logic 1520, in the path of data processing, intercepts and handles all data streams from application 1315 and builds a tunnel to ICU 1310 for data traffic offloading between network connections while maintaining session continuity. The data streams are at a certain network layer, such as at the IP layer, while inside kernel 1510. The tunnel is built through kernel 1510 and through one or both of interfaces 1330 and 1335. Data streams are thus tunneled at the network data layer.

FIG. 16 illustrates a system 1600 in which a mobile station 1605 intercepts a data stream at the interface layer and tunnels the data stream at the network data layer. System 1600 is similar to system 1300 of FIG. 13, with like-identified elements being the same or similar.

In this embodiment, a virtual network interface 1620 is included in mobile station 1605. One or more applications 1315 are configured to use this virtual interface 1620 either through direct configuration or by default of a kernel 1610. Client logic 1625 within virtual interface 1620 intercepts data streams and builds tunnels to ICU 1310 for data traffic offloading while maintaining session continuity. The tunnel is built through a network stack 1615 and through one or both of interfaces 1330 and 1335. Data streams are thus tunneled at the network data layer.

FIG. 17 depicts a network system 1700 in accordance with another embodiment. Network system 1700 is in some ways similar to network system 100 of FIG. 1, with like-named elements being the same or similar. System 1700 additionally includes a wireless access point 1705 that logically splits an enterprise network served by access point 1705 into two WLANs 1710 and 1715, the latter of which is part of an overlay network 1750.

WLAN 1710 is a private network, such as are ubiquitous at small and large institutions and residences, and includes some private storage 1720 and an AAA server 1725. Local wireless devices, represented by a laptop 1730, are authenticated by AAA server 1725 to gain access to WLAN 1710 and storage 1720, and to Internet information source 110. The operation of WLAN 1710 is conventional, and is well understood by those of skill in the art.

Member network 1715 uses a portion of the communication bandwidth available from WAP 1705 to provide access to overlay network 1750. Wireless stations not authorized for access to WLAN 1710 can take advantage of this bandwidth by authenticating either via an optional AAA server 1735 or by communicating with a remote AAA server 150 of overlay network center 140. In effect, WAP 1705 is divided into two virtual access points, one for LAN 1715 inside overlay network 1750 and one for WLAN 1710 outside the overlay network.

Separating one WAP into two or more virtual access points has a number of important advantages. Perhaps the most important is the potential for extraordinary market penetration, and consequent coverage and bandwidth, for a relatively nominal cost. At present, millions of WAPs have surplus bandwidth that goes unused while mobile stations in their vicinity suffer a scarcity of bandwidth. Enterprises, government entities, and private individuals, could be enticed to install split WAPs like WAP 1705 in lieu of traditional WAPs. For example, an enterprise might prefer such a split WAP over a traditional WAP to allow visitors access to the Internet while keeping internal information secured from visitors. Alternatively, the price or usage fee associated with a WAP could be subsidized to encourage the use of split WAPs. WAP 1705 could be configured to allow outside users a certain percentage of total or available bandwidth so as not to unduly encumber the enterprise supporting the WAP. Authentication and other management functionality could take place remotely, as with AAA server 150, so the enterprise, personal, or government operator of WAP 1705 would have no responsibility for provisioning access to those outside WLAN 1710.

Users of wireless devices usually set up guest accounts that allow them to move between wireless networks. Previously, wireless carriers can enter into roaming agreements that allow their customers to roam between wireless networks. These arrangements are typically set up by information technologists (IT professionals) employed by the entities engaged in the agreements, and require setting up inter-AAA server connections between the involved networks. Such setup is complicated and hinders users from taking advantage of the available resources. Further, enterprise IT will often forego such agreements or choose simple, unsecure configurations to reduce costs and complexity. Forgoing the sharing of resources reduces productivity, while lower levels of security subject entities to security breaches, abuse, and potential liability.

Overlay network 1750 facilitates authentication of mobile station 105 between disparately owned or controlled networks with little or no onus on the operators of the member networks. Each member WLAN is conventionally identified by a unique SSID, or service-set identifier, which devices on the WLAN employ to communicate with one another. The SSID on wireless stations can be set either manually, by entering the SSID into the client network settings, or automatically, by leaving the SSID unspecified or blank. Network administrators may set a public SSID for an access point and broadcast the public SSID to all wireless devices in range. Some WAPs disable automatic SSID broadcast features for improved security.

All authentication services for overlay network 1750 can be handled by AAA server 150, so a mobile station can connect to information source 110 from any network able to refer to AAA server 150 for authentication and other services commonly performed by AAA servers. Easing the burdens and avoiding security issues is expected to encourage adoption of split-WAP networks, and thus the expansion of the shared overlay network. Also important, overlay network center 140 controls access to the various member networks, and can therefore manage handoffs between them. Roaming can thus be achieved between WLANs controlled by different entities without complicated arrangements between them, and without threats to security. Moreover, enterprise IT associated with the member networks can easily set up guest accounts for the entire overlay network to allow their users access to expansive roaming resources. Networks outside overlay network 1750 (e.g., cellular network 115) can likewise make additional wireless resources available to their subscribers via overlay network 1750.

There are a number of ways to set up terminals (mobile stations, desktop computers, etc.) in the overlay network. For example, each terminal can be assigned a separate access account (user name and password) for overlay network 1750 via AAA server 150. In business terms, this method is equivalent to each enterprise receiving one or more “seats” for roaming. For example, a single company may have X number of assigned seats to be shared by members of that company. Those users can share an account identifier and have passwords assigned by the company. Enterprise IT for a member network of overlay network 1750 can setup the travelers' terminals with the information of these seats, which would enable roaming access when they are in other members' networks. Alternatively, each roaming terminal can be dynamically authenticated with the credential of its own home network. To authenticate a visiting terminal, AAA server 150 of overlay network 1750 can build a connection to the AAA server of the visiting terminal's home WLAN and authenticate through that connection. Users of member networks can thus experience a “single sign-on” experience when roaming between member networks. Setup is secure and convenient for enterprise IT, and a single business relationship with overlay network 1750 replaces what could otherwise be an unmanageable number of relationships with the member networks.

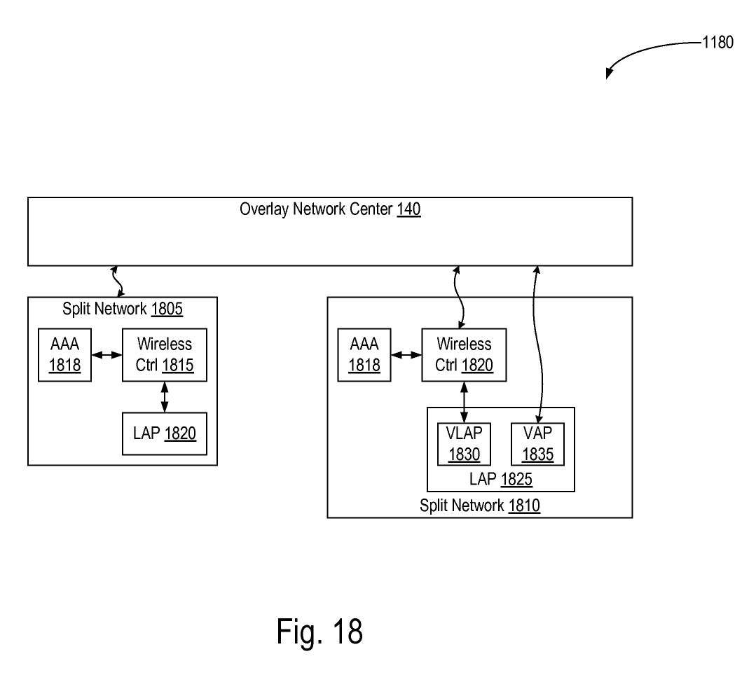

FIG. 18 is a block diagram of a network 1800 that includes overlay network center 140 of FIGS. 1 and 17 connected to a pair of split networks 1805 and 1810, each of which is divided into two virtual networks. The two virtual networks of one split network can be used to implement e.g. member network 1715 and enterprise network 1710 of FIG. 17.

Split network 1805 includes an AAA server 1818, an enterprise wireless controller 1815, and a lightweight access point (LAP) 1825. Controller 1815 is configured to provide two Service-Set Identifiers (SSIDs): one for use with overlay network center 140 and the other to gain access to the information local to network 1805. As is well known, SSIDs are names that identify particular 802.11 wireless LANs. The two SSIDs from controller 1815 should in general be configured onto separate virtual local area networks (VLANs) for security and traffic management. LAP 1825 is controlled and configured by wireless controller 1815 through a lightweight wireless protocol that presents the two SSIDs.

LAPs are well known, so detailed discussions are omitted. Briefly, a LAP supports a set of protocols that define how wireless controllers control and configure a set of wireless access points. There are many different but similar protocols that come from different standard groups or companies. These include the CAPWAP (Control and Provision of Wireless Access Points) protocol that is standardized by IETF (Internet Engineering Task Force). There are also non-standard protocols commonly in use in enterprise wireless products, including Lightweight Access Pointer Protocol (LWAPP) by Airespace (acquired by Cisco), and competing (but similar) protocols by Aruba Network and Meru Networks. CAPWAP is largely based on Airespace/Cisco LWAPP. The word “lightweight” refers to the fact that such protocols are designed to move most of the wireless access control functions from the access point into the wireless controller. This allows the wireless access point device becomes simpler, and presumably less expensive. The wireless control functions are typically more complex than that of consumer-grade access points.

Returning to the example of LWAPP, that lightweight wireless protocol usually builds tunnels between the AP and the controller. The tunnels are usually over Layer 3. Since the access point is mostly a Layer 2 entity, most of the Layer 2 data is sent through the tunnel to the wireless controller for processing. Because the controller processes all the data from the client applications at Layer 2 through the tunnels to LAP, it is possible to manage the access control using Layer 2 protocols (such as IEEE 802.1x) as well as Layer 3 or higher protocols. The controller would also be able to execute and provide other Layer 2 functions as well as Layer 3 or higher layer functions, such as packet routing and retrieving IP address assignments and other configuration information. Configuration information is commonly retrieved using the Dynamic Host Configuration Protocol (DHCP).

In split network 1805, LAP 1825 detects mobile stations entering the LAP's coverage area. Client software within a detected mobile station associates with that network and controller 1815 passes the authentication and authorization to AAA server 1818. Controller 1815 may authorize the requesting mobile station to access network 1805, or may seek further or separate access privileges via an AAA server in overlay network center 140 to provide the mobile station with access to the overlay network. Alternatively, arrangements can be made between network center 140 and split network 1805 for AAA server 1818 to authorize local and overlay-network access.

Split network 1810 includes an AAA server 1818, wireless controller 1820, and an LAP 1825. The LAP is divided into two virtual LAPs 1830 and 1835, each of which functions identical to an LAP and provides SSIDs for wireless access to enterprise mobile stations that require access to resources local to network 1810, and to guest mobile stations that require access to the overlay network.

LAP 1825 detects mobile stations entering its coverage area. When this happens, client software within the mobile station associates with network 1810, and wireless controller 1820 uses AAA server 1818 to authenticate the wireless device in the manner described above in connection with split network 1805.

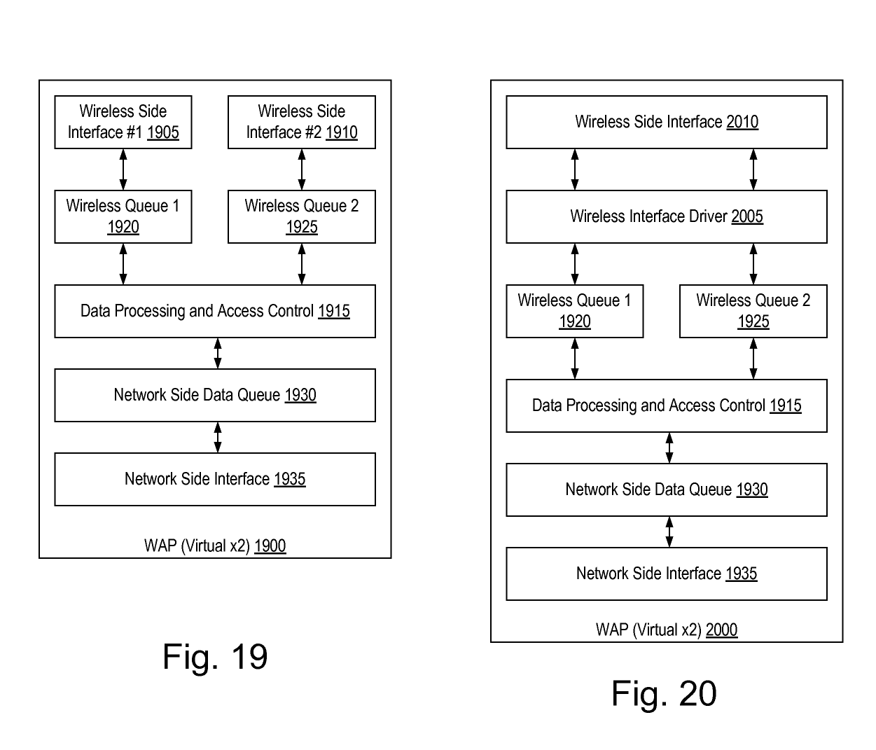

FIG. 19 depicts a WAP 1900 split into multiple virtual access points in accordance with one embodiment. WAP 1900 includes two wireless-side interfaces 1905 and 1910, each of which is coupled to a common data processing and access control block 1915 via a respective one of two wireless queues 1920 and 1925. Control block 1915 communicates with a network side interface 1935 via a network-side data queue 1930. The network-side interface may be wired or wireless, and there may be more than one.

From the perspective of a wireless station (not shown), each interface 1905 and 1910 appears to be an individual access point. In this way, multiple virtual APs are achieved with a single physical AP. The single data processing and access control block 1915 processes all the data and manages the access to both of these virtual APs. Each queue is shown as one unit, but may include multiple queues for e.g. incoming and outgoing data, and there may be separate data queues for different data flows, for different quality-of-service (QoS) classes for example.

For this embodiment, there is only one Data Processing and Access Control block 1915, even though the data flows for each of the virtual APs are going through different queues. Most of the AP functions from Layer 2 and up may be handled by this unit. For example, these AP functions can be implemented using the network part of the kernel of Linux together with Linux Packet Filter. Because many of the queue handling and packet processing are going through the same Linux kernel process in such embodiments, resource allocation (either statically or dynamically) between different virtual APs can be difficult. There is also complexity arising from processing multiple data flow with one process. Remote management of some virtual APs poses a security risk for this embodiment, as does the mixing the management data flow and data flow from mobile stations of various virtual APs. Care should therefore be taken to address these issues in sensitive applications.

FIG. 20 depicts a WAP 2000 split into multiple virtual access points in accordance with another embodiment. WAP 2000 is similar to WAP 1900 of FIG. 19, with like-identified elements being the same or similar. This embodiment can be implemented using the same hardware as a conventional wireless access point running software that defines the virtual access points.

In general, mobile stations identify different APs by the BSSID (Basic Service Set Identifier) and/or the SSID (Service Set Identifier) used by the APs. The BSSID is the Media Access control (MAC) address of the wireless interface, and the SSID is usually a name string assigned by the operator of the AP. The SSID and the BSSID are usually included in the beacon that is broadcasted by the AP. A mobile station, receiving the beacons (broadcasted by AP or transmitted after probe), is then able to identify and initiate connection to the APs. In a traditional form, each AP uses one SSID and one BSSID, thus is seen as one AP to the mobile station.

Even though not part of the 802.11 standard, some wireless interfaces may be able to support multiple SSIDs and even multiple BSSIDs. This can be controlled through the wireless interface driver 1160. When this setup is configured by the interface driver, the AP will broadcast or transmit multiple beacons (potentially with different BSSID) and/or multiple SSID within each beacon. (As is well known, beacon-enabled networks transmit beacons periodically as the synchronization signals.) From the wireless station's perspective, it appears that there are multiple APs that are serving connections. In this way, multiple virtual APs are achieved with a single physical AP.

The beacons of the wireless interfaces may be configured in many different ways. In general, while each beacon uses one BSSID, it may have one or more SSIDs. In additional, it is possible to use multiple beacons. The following lists a few common possibilities: Multiple beacons, each beacon with a single SSID, each beacon having a different SSID and BSSID; Multiple beacons, each beacon with a single SSID, all beacons have different SSID while sharing the same BSSID; A single beacon (thus a single BSSID), and it contains multiple SSIDs. A combination of the above may be used to create more complex scenario. For example, one may use multiple beacons, each with multiple SSIDs.

In FIG. 20, a wireless interface driver 2005 is depicted as explicitly separate from a wireless interface 2010. Interface 2010 can be controlled by driver 2005 to send beacons and set-up communication channels with various SSID and BSSID for data queues 1920 and 1925. The end result is that the wireless mobile stations will see multiple virtual APs provided by the same physical AP. As in the example of FIG. 19, access point 2000 includes only one Data Processing and Access Control block 1915. As a result, limitations discussed above for the embodiment of FIG. 19 apply equally here.

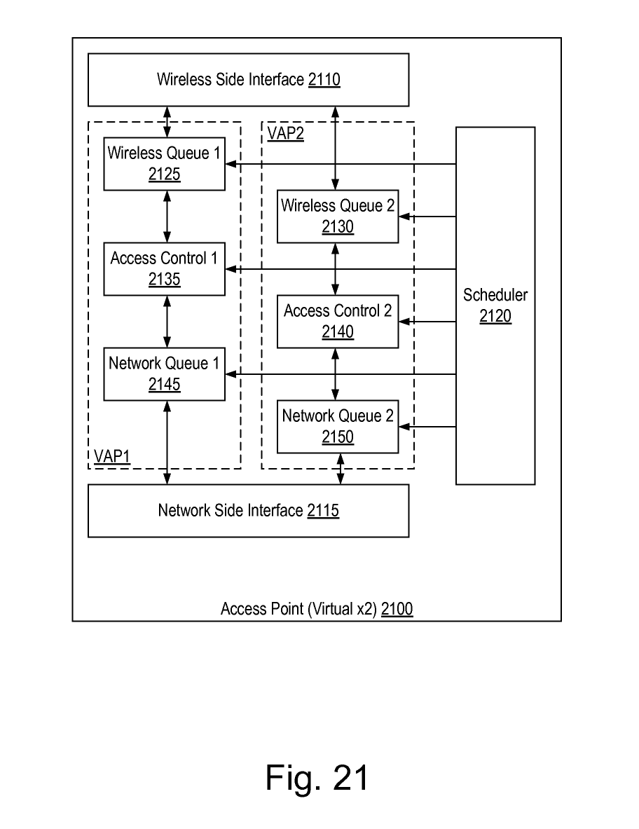

FIG. 21 is a block diagram of a WAP 2100, an embodiment of WAP 1705 of FIG. 17. WAP 2100 includes wireless-side interface 2110, and network-side interface 2115, two virtual access points VAP1 and VAP2, and a scheduler 2120 that arbitrates between the two virtual access points. Other embodiments can include additional virtual access points. Wireless side interface 2110 communicates with wireless devices, such as mobile station 105; network interface 2115 communicates with overlay network center 140 via any suitable wired or wireless network connections. Each of VAP1 and VAP2 functions as a conventional access point. Each includes a wireless-side queue 2125/2130, an access control unit 2135/2140, and a network-side queue 2145/2150. Scheduler 2120 controls the relative bandwidths of VAP1 and VAP2 using rule sets either hard-wired or programmed into scheduler 2120.

There is complete separation between virtual access points VAP1/VAP2, and they may have different address space in shared or separate physical memory. Separate address space provides a secure barrier between the networks that communicate via the virtual access points. Furthermore, the two virtual access points can be configured separately, and by separate entities. For example, the managers of the respective networks can be presented with separate management interfaces (e.g. web-based configuration pages) for setting up the parameters that pertain to each of the virtual access points. There may also be a separate configuration interface for inter-virtual-access-point configurations, such as partitioning, dynamic scheduling, etc.

The ability to dynamically adjust the partition of resources between virtual access points is an important aspect of some embodiments. For example, the owner, the manager, and the user of the physical device and the virtual access point or points may be different entities, and different business arrangements may be put in place between them. For example, different service plans may offer different service levels and pay rates. Service parameters, such as the partition boundary, the schedule, upper bandwidth limits, etc., may be dynamically adjusted between the virtual access points. Such allocations can be handled by the scheduler. Optionally, these may also be controlled remotely by the manager of the virtual access points. The following examples are illustrative.

An owner of WAP 2100 may agree to allow access to visiting devices in exchange for some service, such as reciprocal access, or a fee. Such access could be limited to e.g. no more than 10% of the total available bandwidth of WAP 2100. The bandwidth partition can vary dynamically with actual or expected usage. For example, the shared bandwidth may be set at no more than 25% during peak usage hours and no more than 40% during off peak usage hours, or may be set to allocate up to e.g. 85% of the resources not in use by the owner. The scheduler may also be instructed to schedule traffic based on the profile of the user that initiates the connection. A user with a premium account can use a higher percentage of the resources (e.g., 50% of the available bandwidth) or a higher priority in queue for their real time data traffic (e.g., video traffic), while a user with a base subscription will be limited to a lower level (e.g., 10% of the available bandwidth). Many other provisions for sharing bandwidth between multiple virtual access points are possible.

Modern computer technology has seen a lot of advances in virtualization. A hardware computing platform may be presented as one or more virtual machines. Operating systems (OS) and applications may be run on those virtual machines, in which case the OS is commonly referred to as a guest OS. From the perspective of the guest OS, the guest OS is running on a dedicated physical platform and has control of all the resources of that platform. In this way, multiple operating systems (and their instances) may be run on the same physical platform. The benefit is usually improved hardware utilization. The concept of virtualization is applied to WAPs in accordance with some embodiments. That is, multiple VAPs may be run as virtual instances on a single physical WAP.

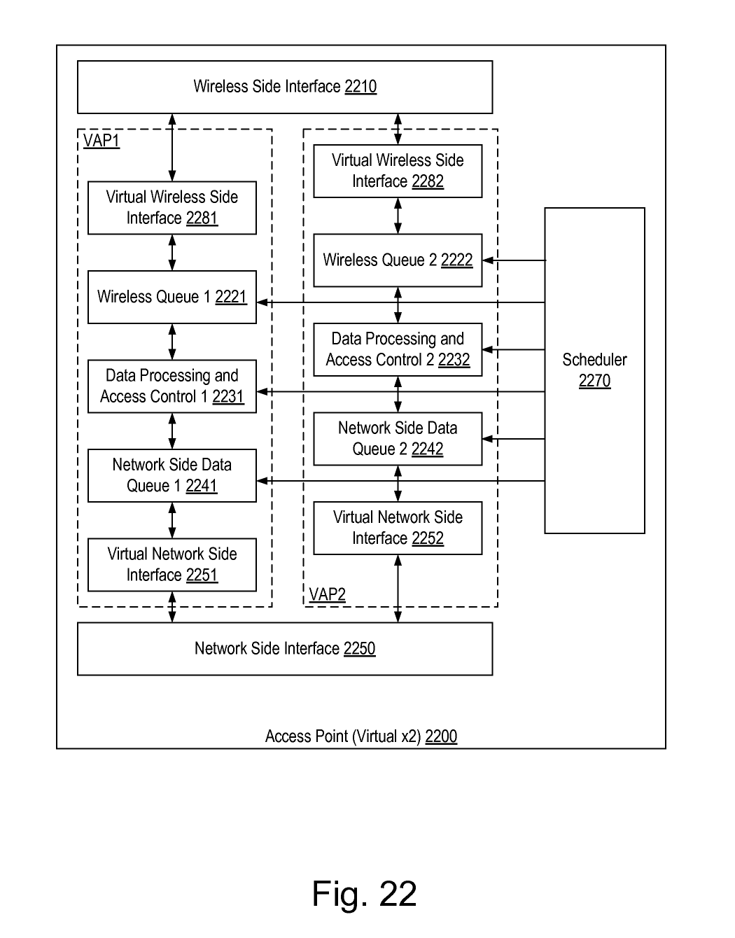

FIG. 22 illustrates an embodiment of an AP 2200 in which is instantiated two virtual AP instances VAP1 and VAP2 on virtualized platforms. VAP1 and VAP2 respectively includes virtual wireless-side interfaces 2281/2282, wireless queues 2221/2222, data processing and access control units 2231/2232, network-side data queues 2241/2242, and virtual network-side interfaces 2251/2252. VAP1 and VAP2 communicate with outside networks via physical interfaces 2210 and 2250. Each virtualized access point VAP1 and VAP2 is configured to set its own BSSID and SSID for signals communicated via the physical interfaces. Access point 2200 thus appears as multiple access points from the perspective of a wireless mobile station. The respective components of virtual access points VAP1 and VAP2 may be executing in completely separate address space and in a different processing contexts. This logical separation provides very clean data separation and security.

A scheduler 2270 allocates resources (e.g. processing time slot, bandwidth, etc.) between the virtual access points. In this embodiment, the scheduler 2270 could be implemented in a few different ways. Scheduler 2270 may, for example, be implemented in a separate virtual environment, and may control each virtual access point VAP1/VAP2 through defined control interfaces as depicted in FIG. 22. Scheduler 2270 may also allocate resources through the virtualization layer. For example, scheduler 2270 can decide how much processing time or bandwidth each of the virtual machine receives, and thus modulate the execution of each virtual access point.

The virtual access points detailed previously do not represent an exhaustive list, and elements of each embodiment can be used in combinations with elements from other embodiments.

An output of a process for designing an integrated circuit, or a portion of an integrated circuit, comprising one or more of the circuits described herein may be a computer-readable medium such as, for example, a magnetic tape or an optical or magnetic disk. The computer-readable medium may be encoded with data structures or other information describing circuitry that may be physically instantiated as an integrated circuit or portion of an integrated circuit. Although various formats may be used for such encoding, these data structures are commonly written in Caltech Intermediate Format (CIF), Calma GDS II Stream Format (GDSII), or Electronic Design Interchange Format (EDIF). Those of skill in the art of integrated circuit design can develop such data structures from schematic diagrams of the type detailed above and the corresponding descriptions and encode the data structures on computer readable medium. Those of skill in the art of integrated circuit fabrication can use such encoded data to fabricate integrated circuits comprising one or more of the circuits described herein.

While the present invention has been described in connection with specific embodiments, variations of these embodiments are also contemplated. For example, the technology used for the ancillary network is also not limited to WiFi, but can also be any one or a combination of a large set of existing or emerging technologies, such as WiMax or whitespace radio. Furthermore, the ancillary network can be either a real access network (with deployed access points), or a virtual aggregated virtual network. Different method of data-stream interception or tunneling may be used, and there are many combinations of control and path selection algorithms that may be used with the above-described or other embodiments. Still other variations will be obvious to those of ordinary skill in the art. Moreover, some components are shown directly connected to one another while others are shown connected via intermediate components. In each instance the method of interconnection, or “coupling,” establishes some desired electrical communication. Such coupling may often be accomplished in many ways using various types of intermediate components and circuits, as will be understood by those of skill in the art. Therefore, the spirit and scope of the appended claims should not be limited to the foregoing description. Only those claims specifically reciting “means for” or “step for” should be construed in the manner required under the sixth paragraph of 35 U.S.C. Section 112.

What is claimed is:

1. A network comprising:
an interworking control unit; and
an interworking authentication server;
wherein at least one of the interworking control unit and the interworking authentication server is coupled to (i) a cellular network having a cellular-network authentication server and (ii) a local-area network (LAN) having a LAN authentication server,
the interworking authentication server selectively authenticating at least one of: (i) a cellular connection between a mobile station and an Internet information resource via the cellular network and (ii) a wireless connection between the mobile station and the Internet information resource via the LAN.

2. The network of claim 1, wherein the internetworking authentication server authenticates the mobile station via the cellular network and the LAN.

3. The network of claim 2, wherein the cellular authentication server authenticates the mobile station via the cellular network, and wherein the interworking and cellular authentication servers require different authentication information from the mobile station to authenticate the mobile station.

4. The network of claim 1, wherein the cellular network is a wireless wide-area network and the LAN is a wireless LAN.

5. The network of claim 1, wherein the interworking control unit receives authentication information from the cellular network and the LAN and establishes the at least one connection based on the authentication information.

6. The network of claim 1, wherein the interworking control unit receives authentication information from the cellular network and the LAN and registers at least one connection path based on the authentication information.

7. The network of claim 1, wherein the network is controlled by a first service provider and the cellular network is controlled by a second service provider.

8. The network of claim 7, wherein the LAN is controlled by a third service provider.

9. The network of claim 1, wherein the interworking control unit includes a first network interface to communicate with the mobile station, a second network interface to communicate with the Internet information resource, and a path switch to select between the cellular connection and the wireless connection.

10. The network of claim 9, wherein the cellular network offers a first cost-per-byte and the LAN offers a second cost-per-byte, wherein the interworking control unit further includes path selection logic to select between the cellular connection and the wireless connection based, at least in part, on the first and second costs-per-byte.

11. The network of claim 1, wherein the cellular-network authentication server authenticates the mobile station and does not authenticate a second mobile station.

12. The network of claim 11, wherein at least one of the interworking control unit and the interworking authentication server is coupled to a second cellular network having a second cellular-network authentication server that authenticates the second mobile station, and wherein the interworking authentication server selectively authenticates a second cellular connection between the second mobile station and the Internet information resource.

13. The network of claim 12, wherein the interworking authentication server selectively authenticates a second wireless connection between the second mobile station and the Internet information resource via the LAN.

14. A method of authenticating a wireless mobile station for communication with an Internet information resource via at least one of a cellular network or a local-area network (LAN), the method comprising:
receiving, via the cellular network, first authentication information from the mobile station, authenticating the mobile station, and setting up a first data path from the mobile station to the Internet information resource via the cellular network; and
receiving, via the LAN while the first data path is set up, second authentication information from the mobile station, authenticating the mobile station, and setting up a second data path from the mobile station to the Internet information resource via the LAN.

15. The method of claim 14, wherein the first and second authentication information are the same.

16. The method of claim 14, wherein the cellular network authenticates the mobile station using third authentication information different from the first and second authentication information.

17. The method of claim 14, further comprising tearing down the first data path after setting up the second data path.

18. The method of claim 14, wherein the cellular network authenticates the mobile station before sending the first authentication information.

19. The method of claim 14, wherein the LAN authenticates the mobile station before sending the second authentication information.

20. The method of claim 14, wherein the cellular network offers a first cost-per-byte and the LAN offers a second cost-per-byte, the method further comprising selecting the second data path based upon the first and second costs-per-byte.

21. An overlay network for authenticating a mobile station, the overlay network comprising:
a plurality of member networks, each member network including a wireless access point and a member authentication server to authenticate access to the member network, wherein the member authentication sever of at least one of the member networks refuses access to the mobile station; and
an overlay network center coupled to each of the wireless access points and having an overlay authentication server to authenticate the mobile device for access to the overlay network using the wireless access point of the member network that refuses access to the mobile station.

22. The overlay network of claim 21, wherein the member networks are owned by separate enterprises and provide the mobile station access to an Internet information resource via the overlay network.

23. The overlay network of claim 21, further comprising a connection to a cellular network having a cellular authentication server to authenticate access of the mobile station to the cellular network based on first credentials associated with a user the mobile device, the overlay authentication server to authenticate the mobile station for access to the overlay network based on second credentials associated with the user of the mobile device.

24. The overlay network of claim 21, wherein the overlay authentication server establishes multiple paths from the mobile station to an Internet information resource through respective ones of the member networks.

25. The overlay network of claim 24, wherein the overlay authentication server includes a path switch that switches between the paths.

26. The overlay network of claim 24, wherein establishing a path includes registering the path and authenticating the mobile station.

27. A network comprising:
an interworking authentication server for selectively authenticating at least one of: (i) a cellular connection between a mobile station and an Internet information resource via a cellular network and (ii) a wireless connection between the mobile station and the Internet information resource via a local-area network (LAN); and
the cellular network having a cellular-network authentication server and the LAN having a LAN authentication server.

28. The network of claim 27, wherein the interworking authentication server authenticates the mobile station via the cellular network and the LAN.

29. The network of claim 28, wherein the interworking authentication server authenticates the mobile station for simultaneous communication with the Internet information resource via the cellular network and the LAN.

30. The network of claim 28, wherein the cellular authentication server authenticates the mobile station via the cellular network, and wherein the interworking and cellular authentication servers require different authentication information from the mobile station to authenticate the mobile station.

31. The network of claim 27, wherein the network is controlled by a first service provider and the cellular network is controlled by a second service provider.

32. The network of claim 31, wherein the LAN is controlled by a third service provider.
